(19) United States
(12) Patent Application Publication
(10) Pub. No.: US 2009/0039637 A1
(43) Pub. Date: Feb. 12, 2009

(54) Waterproof and tear-resistant book

(75) Inventor: Roger Burrows, Wilton, CT (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Sandvik Innovations, LLC

(21) Appl. No.: 11/890,913

(22) Filed: Aug. 7, 2007

(51) Int. Cl. B42D 1/00

(52) U.S. Cl. 281/38; 281/21.1

(57) ABSTRACT

A waterproof book is disclosed. The book has a plurality of synthetic paper pages. The synthetic paper pages are substantially waterproof and tear-resistant. The book includes a pressure binding configured to bind the pages into book form while preserving structural integrity of the pages, and without piercing the pages.

### BACKGROUND

Books generally deemed safe for infants and children are commercially available. These include books manufactured from paper, board, felt, vinyl, polyethylene, EVA foam, molded plastic pages, fabric, and synthetic paper. However, books made from many of these materials can easily be fragmented when subjected to water, pulling, peeling, or chewing, and any fragmentation of a young child's book into small parts can create a choking hazard.

Traditional paper and board is made of wood fiber, or other cellulose fibrous materials, that break down in water and also can be torn and can fragment into small parts. Felt fibers can easily break down and felt can fragment to create a choking hazard. Vinyl, polyethylene, and ethylene vinyl acetate (EVA) sheets can tear or fragment. Hard molded plastic pages and fabric pages, although generally safe if manufactured correctly, do not have the commercially and aesthetically desirable look and feel of paper pages or board pages.

Books have been manufactured using various types of synthetic paper, but the selection of the synthetic materials and the methods of binding them to form a book weaken the structural integrity of the synthetic paper. Synthetic papers, particularly cross-fiber synthetic papers, are generally resistant to tearing. However, puncturing the synthetic materials can weaken the structural bonds and create shear points from which the synthetic papers can be torn. If the pages are pierced (e.g., by sewing or stapling) or if the papers are die-cut or punched to form holes (e.g., small-diameter circles, or shapes having sharp corners or edges), such papers can readily be torn.

### SUMMARY OF THE DISCLOSURE

Illustrative, but by no means the only, embodiments disclosed herein provide a book that is substantially waterproof and tear-resistant. The book has a plurality of synthetic paper pages that are substantially waterproof and tear-resistant. The book includes a pressure binding configured to bind the pages into book form while preserving structural integrity of the pages, and without piercing the pages.

Additional objects, advantages, and novel features will be set forth in part in the description, examples, and figures which follow, and in part will become apparent to those skilled in the art on examination of the following, or may be learned by practice of the disclosure.

### BRIEF DESCRIPTION OF THE DRAWINGS

For the purpose of illustrating the herein described systems and methods, drawings are provided; with the understanding, however, that the herein described system and methods are not limited to the precise arrangements and instrumentalities shown.

FIG. 1 is a front view of the disclosed embodiment of a waterproof book.

FIG. 2 is an exploded front view of a pressure binding in accordance with the disclosed embodiment.

FIG. 3 is an exploded front view of a book in accordance with the disclosed embodiment.

FIG. 4A is an side view of the spine of a book, showing an outer binding, in accordance with the disclosed embodiment.

FIG. 4B is an side view of the opposite side of an outer binding such as that illustrated in FIG. 4A.

FIG. 4C is a front view of an outer binding such as that illustrated in FIG. 4A.

FIG. 4D is an end view of an outer binding such as that illustrated in FIG. 4A.

FIG. 5A is a side view of an inner binding in accordance with the disclosed embodiment.

FIG. 5B is a front view of an inner binding in accordance with the disclosed embodiment.

FIG. 5C is an end view of an inner binding such as that illustrated in FIG. 5A.

FIG. 6 is a perspective view of the top of an open book according to the disclosed embodiment.

FIG. 7 is an exploded perspective view of the bottom of an open book such as that illustrated in FIG. 6.

FIG. 8 is a perspective view of the top of an open book having flaps according to a further embodiment.

### DETAILED DESCRIPTION

Illustrative, but by no means the only, embodiments disclosed herein provide a book that is substantially waterproof and tear-resistant, that is, having pages that are generally not tearable by a three-year-old child. An exemplary book may include pages made of high-density cross-fiber synthetic paper and a binding assembly, which may be made of molded plastic. In an illustrative embodiment, synthetic paper may be pre-cut into rectangular pages to be bound. The binding includes an inner binding and an outer binding. The inner binding and the outer binding are fastened together such that the synthetic paper is trapped (e.g., at a center fold) and secured by pressure between the inner and outer bindings. Trapping the synthetic paper without puncturing it eliminates potential shear points that can contribute to tearing. A hinged fastener may be provided for securing a cover to the outer binding, thereby avoiding the use of glues and threads that can degrade in water.

Synthetic paper pages may be made of any of various suitable materials. Most types of synthetic paper are waterproof, and many types are tear-resistant but not tear-proof, particularly if sharp corners are cut into the material or the sheets are punctured in any fashion, or if die-cut edges are rough. Of the synthetic papers commercially available, cross-fiber types offer the highest level of tear resistance, but performance of a particular cross-fiber synthetic paper depends upon factors such as the structural integrity of the fibers, the weight of the composite plastics, and the methods employed in die-cutting and assembling the sheets into an end product.

Examples of the types of commercially available synthetic paper that may be used to form synthetic paper pages include the following illustrative materials: (i) a composite laminate consisting of a strong tear resistant center-ply material bonded between two layers of superior quality coated or uncoated paper (e.g., Duralon™ paper, commercially available from Arlon); (ii) a polypropylene plastic film (e.g., YUPO® synthetic paper, commercially available from Yupo Corporation of America); (iii) a mineral-filled polypropylene synthetic paper (e.g., PRO-Prints synthetic paper, commercially available from Transilwrap Company, Inc.); (iv) a polypropylene film reinforced with various fillers (e.g., Spectralite® synthetic paper, commercially available from Multi-Plastics, Inc.); (v) a synthetic paper produced from a film of expanded high-density polyethylene that has been simultaneously biaxially oriented (e.g., Polyart® synthetic paper, commercially available from Arjobex); (vi) a polyolefin single- and cross-fiber based sheet (e.g., synthetic non-tearable paper commercially available from Amtrex International); and (vii) a spunbonded olefin synthetic paper formed by a process using continuous and very fine fibers of 100 percent high-density polyethylene that are randomly distributed and nondirectional (e.g., Tyvek®, commercially available from E. I. du Pont de Nemours and Company). Spunbonded olefin, in a weight of at least about 105 grams per square meter, is believed to be durable, substantially waterproof and substantially tear-proof when assembled into a book using the disclosed pressure binding.

As an additional safety measure (e.g., for compliance with governmental flame retardancy standards), a flame retardant may be applied, if desired, to surfaces of the spunbonded olefin or other materials comprising the synthetic paper pages. The synthetic paper pages may be printed using any of various suitable printing processes, such as offset printing, silkscreen printing, direct printing, sublimation printing, digital printing, laser printing, and ink jet printing, or other printing methods. If desired, the synthetic paper pages may be embossed.

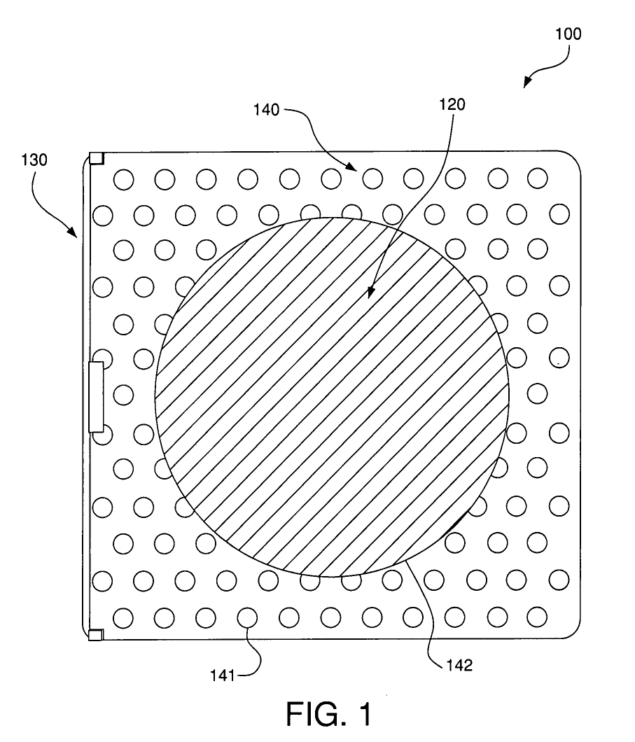

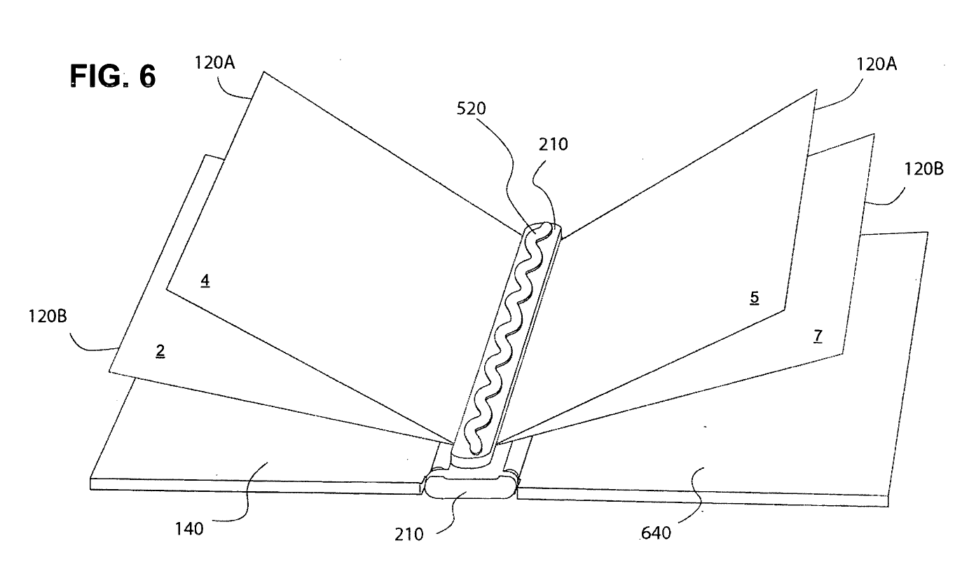

Referring to the drawings, in which like reference numerals indicate like elements, FIG. 1 is a front view of a book 100 in accordance with the disclosed embodiment. Pressure binding 130 secures pages 120 between a front cover 140 and a back cover 640 (shown in FIGS. 6, 7, and 8). In the illustrated embodiment, a portion of a page 120 is visible through an aperture 142 that may be formed, if desired, in the front cover 140; however, no aperture 142 is necessary.

Pressure binding 130 and covers 140, 640 are formed from waterproof and tear-resistant or tearproof materials such as, for example, hard plastic, such as molded acrylonitrile butadiene styrene (ABS) plastic, or other hard plastics or hard vinyls. Additional examples of suitable materials for covers include high-density foams, and plastic laminated boards.

Covers 140, 640 may be printed, may be wholly or partially coated with a heat-sensitive ink, and may include any of various ornamental or functional features; for example, one or more apertures 142, or one or more dimples 141, which may, if desired, be formed or treated (e.g., rubberized) in such a way as to allow a child reader to grip the book 100 more securely. In some embodiments, a handle (not shown) may be provided on the cover. In further embodiments, any of front cover 140, back cover 640, and/or handle, may include one or more audiovisual event generators, such as a speaker, bell, or buzzer for generating an audible event, or a light, LED, video screen, or electronically-triggered mechanical device for generating a visible event.

In still further embodiments, all or a portion of the front cover 140 and/or back cover 640 may be hollow, with the hollow portion forming a container. The contents of the hollow portion may, in some embodiments, be visible through a transparent portion of the cover 140, 640. The hollow portion may contain a fluid (e.g., water). In further embodiments, the hollow portion may contain a plurality of ornamental items. Examples of ornamental items include beads, particles of glitter, and items representing creatures or other shapes relevant to the text of the book 100. Ornamental items may include items configured to make sounds (e.g., to rattle) when the book 100 is shaken.

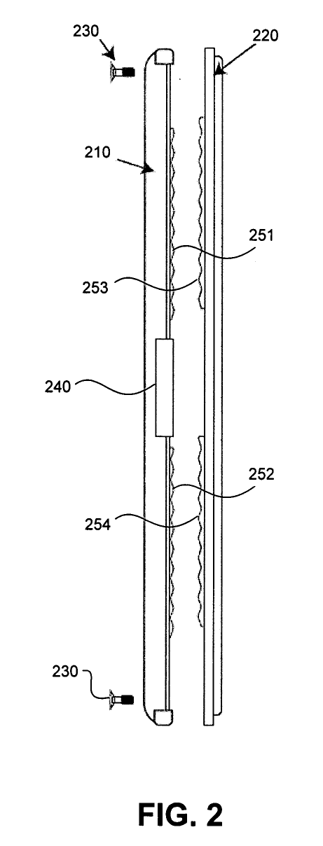

FIG. 2 depicts an exploded front view of a pressure binding 130 in accordance with the disclosed embodiment. Pressure binding 130 includes an outer binding 210, inner binding 220, and one or more fasteners 230 (for example, pins, screws, rivets, or other fasteners) for securing the outer binding 210 to the inner binding 220. Fasteners 230 allow outer binding 210 and inner binding 220 to be assembled tightly to provide a pressure fit, securely trapping one or more pages 130 (not shown) between the inner binding 220 and the outer binding 210. Fasteners 230 may also be secured using an adhesive such as glue or epoxy.

The outer binding 210 includes one or more surfaces, such as shaped surfaces 251, 252, formed to fit into one or more corresponding surfaces of the inner binding 220, such as shaped surfaces 253, 254. Shaped surfaces 251, 252 may be raised surfaces, and may be formed integrally with outer binding 210. Shaped surfaces 253, 254 may be raised surfaces, and may be formed integrally with inner binding 220. The shaped surfaces 251, 252, 253, and 254 can be configured to form mutually interengaging faces of the outer and inner bindings 210, 220. In an illustrative example, shaped surfaces 251, 252 of the outer binding 210 may include notches or ribs that fit into corresponding or complementary notches or ribs of shaped surfaces 253, 254 of the inner binding 220. The shaped surfaces 251, 252, 253, and 254 are configured to prevent movement of pages 130 trapped by pressure between the outer and inner bindings 210, 220.

Any of a wide variety of waterproof and tearproof means, such as hinges or rings, may be used to attach covers to the pressure binding 130. In some embodiments, the outer binding 210 includes a cover mounting 240 (e.g., a clip-fit or snap-fit mounting or hinge member) for hingedly securing front cover 140 to the outer binding 210. A corresponding cover mounting (not shown) may be provided on the opposite side of the outer binding 210 for hingedly securing back cover 640 to the outer binding 210. In some embodiments, a handle (not shown) may be provided on the outer binding 210.

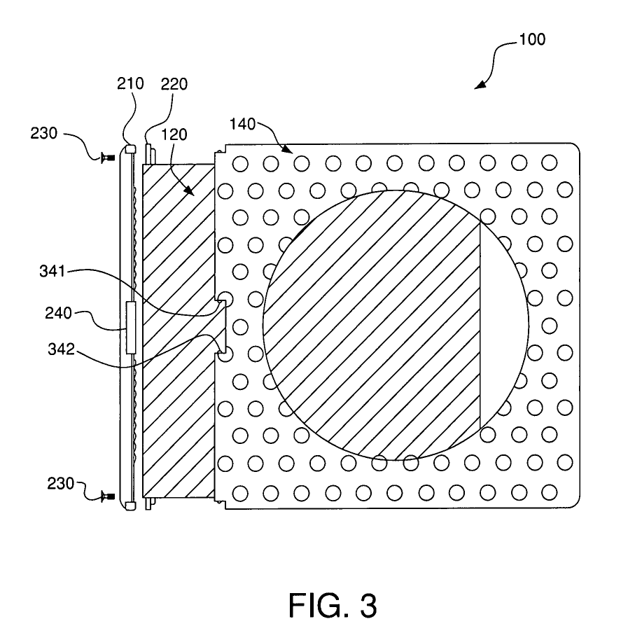

FIG. 3 depicts an exploded front view of a book 100 in accordance with the disclosed embodiment. In an illustrative example of a suitable hinge, cover 140 is provided with rounded protrusions 341, 342 that are able to snap into corresponding depressions (not shown) in the cover mounting 240 for receiving the protrusions 341, 342, thereby forming a hinge for opening and closing the cover 140. For example, cover mounting 240 may include a hollow cylinder, into which the protrusions 341, 342 may be snapped, and within which the protrusions 341, 342 are rotatable. However, numerous other configurations for one or more hinges securing cover 140 to the outer binding 210 will be apparent to one skilled in the art.

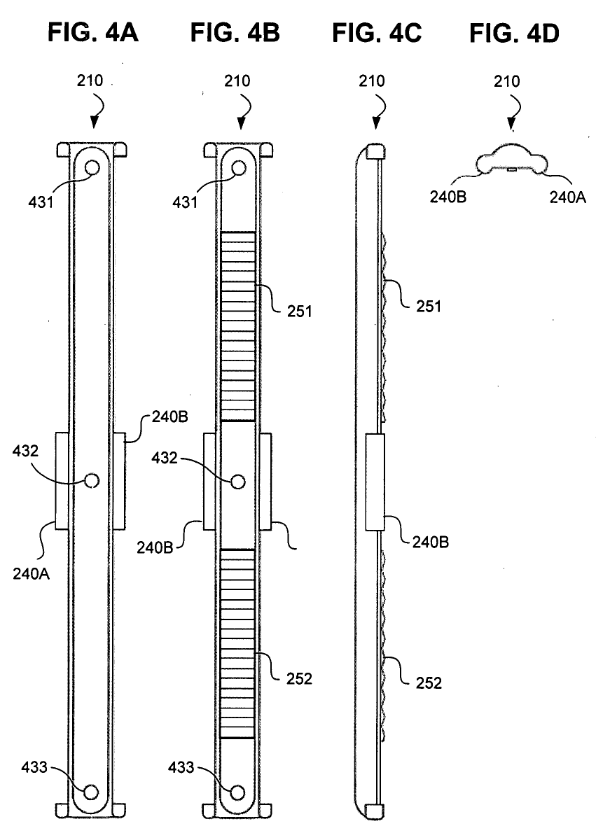

An outer binding 210 in accordance with the disclosed embodiment is depicted in FIG. 4A, FIG. 4B, FIG. 4C, and FIG. 4D. In FIG. 4A, a side view of the spine of book 100 is shown. FIG. 4B depicts a side view of outer binding 210 opposite the side illustrated in FIG. 4A. FIG. 4C shows a front view of an outer binding 210 such as that illustrated in FIG. 4A. FIG. 4D shows an end view of outer binding 210. Holes 431, 432, 433 are provided to receive fasteners 230 (not shown). Cover mounting 240A is provided for hingedly securing back cover 640 to the outer binding 210. Cover mounting 240B is provided for hingedly securing front cover 140 to the outer binding 210.

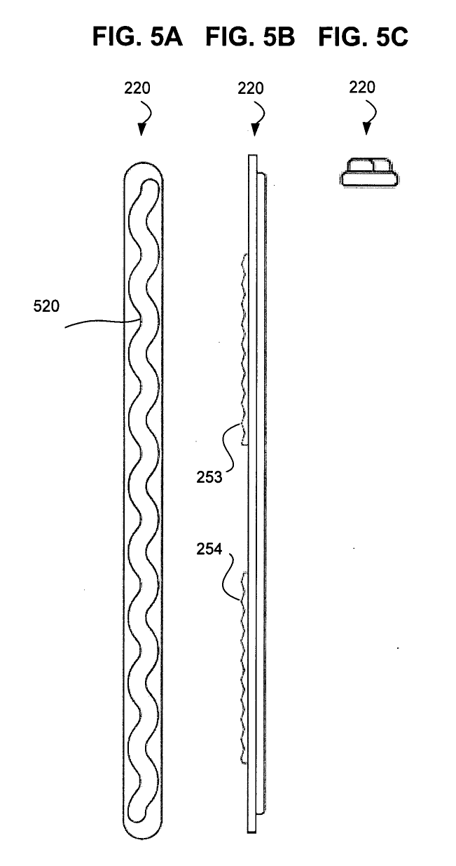

An inner binding 220 in accordance with the disclosed embodiment is depicted in FIG. 5A, FIG. 5B, and FIG. 5C. In FIG. 5A, a side view of the inner binding 220 is shown, depicting the side of inner binding 220 opposite shaped surfaces 253, 254. In some embodiments, an ornamental pattern 520 may be provided; e.g., molded into the inner binding 220. FIG. 5B shows a front view of an inner binding 220 such as that illustrated in FIG. 5A. FIG. 5C shows an end view of inner binding 220.

In addition to the foregoing embodiments of pressure binding 130, further embodiments of pressure binding 130 may be formed in a wide variety of additional configurations that will be apparent to one skilled in the art. For example, the outer binding 210 and inner binding 220 of pressure binding 130 may be joined to one another in an interengaging relationship by at least one fastener 230. In an illustrative example, the outer binding 210 and inner binding 220 are pivotably joined, such as by a hinge. In a further embodiment, the hinge may be a living hinge integral with both the outer binding 210 and inner binding 220, thereby allowing the outer and inner bindings 210, 220 to be formed in one piece. In such an embodiment, the pressure binding 130 may be folded at the hinge so as to grip the pages between the outer and inner bindings 210, 220, and then fastened using at least one fastener 230.

FIG. 6 is a perspective view of the top of an open book 100 according to the disclosed embodiment. Between front cover 140 and back cover 640, the book 100 includes pages formed from sheets of synthetic paper. In the illustrated example, pages are shown formed from two single sheets of synthetic paper, sheet 120A and sheet 120B. Sheets 120A, 120B are folded in half around inner binding 220 and trapped by pressure between inner binding 220 and outer binding 210. According to usual conventions for page numbering, after folding, sheet 120B forms pages 1, 2, 7, and 8 of the book 100, and sheet 120A forms pages 3, 4, 5, and 6 of the book 100. Numbered pages 2, 4, 5, and 7 are visible in FIG. 6. Numbered pages 1, 3, 6, and 8 (not shown) are on the opposite sides of pages 2, 4, 5, and 7 respectively.

In a further embodiment, sheets 120A and 120B may each be formed from two or more layers of synthetic paper, bonded or sealed together; e.g., by an adhesive (such as glue or epoxy), or heat sealed. In a still further embodiment, edges of sheets 120A and 120B may be hemmed, provided that the sheets 120A, 120B are not sewn or otherwise punctured on exposed edges or surfaces. For example, an edge may be hemmed by folding a flap inward from the edge to form a two-layer edge portion, and bonding or sealing the two layers together; e.g., by an adhesive (such as glue or epoxy) or by heat sealing.

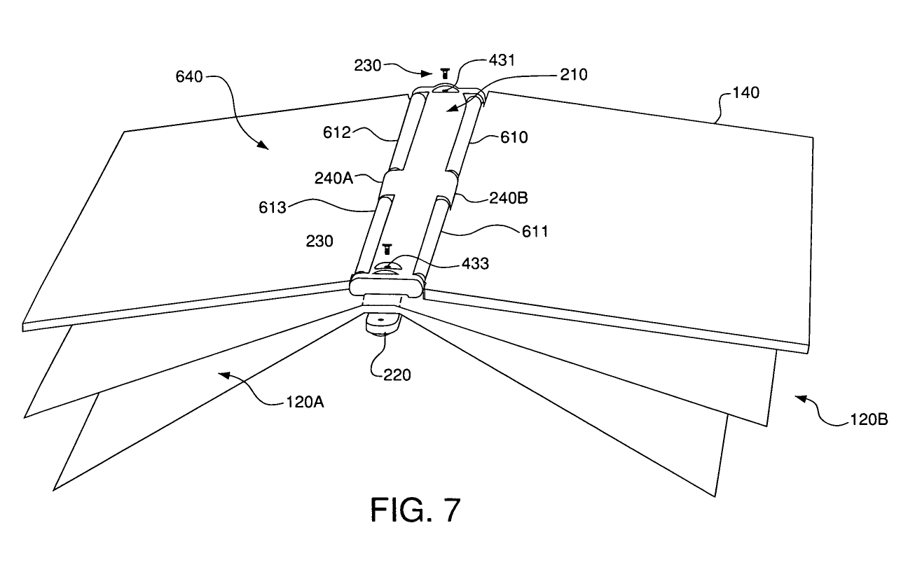

FIG. 7 is an exploded perspective view of the bottom of an open book 100 such as that illustrated in FIG. 6. Front cover 140 is provided with rounded portions 610, 611 having protrusions 341, 342 (see FIG. 3) in communication with cover mounting 240B, for hingedly securing front cover 140 to the outer binding 210. Back cover 640 is provided with rounded portions 612, 613 having corresponding protrusions (see FIG. 3) in communication with cover mounting 240A, for hingedly securing back cover 640 to the outer binding 210.

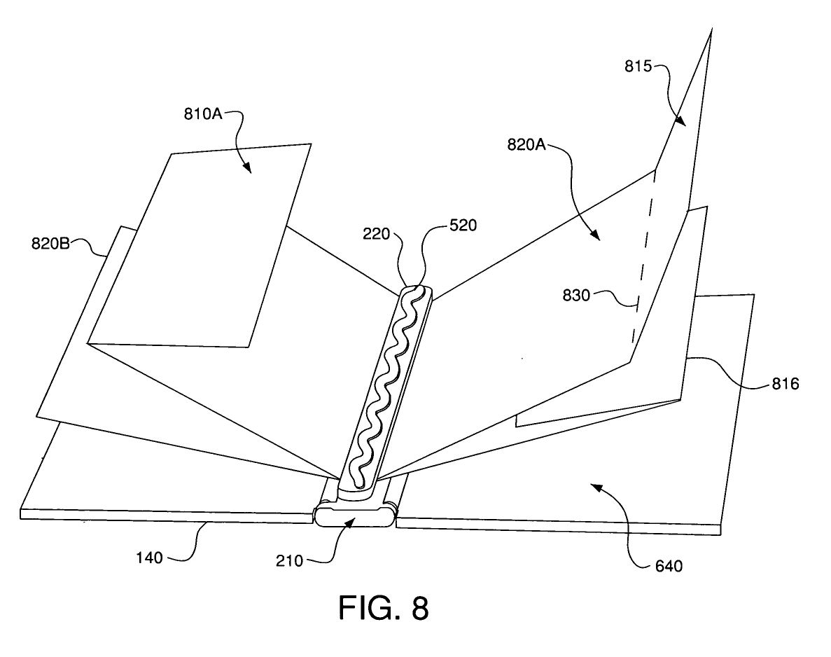

FIG. 8 is a perspective view of the top of an open book 100 having flaps, according to a further embodiment. Sheet 820A is a single sheet of synthetic paper, and sheet 820B is a single sheet of synthetic paper. Sheets 820A, 820B are longer than sheets 120A, 120B shown in FIG. 6, so that flaps 810, 815, 816 may be formed. For example, flap 815 is formed without puncturing the synthetic paper of sheet 820A, by folding sheet 820A along fold line 830. Similarly, flap 810 is formed by folding sheet 820A on the opposite side of inner binder 220, and flap 816 is formed by folding sheet 820B. In a still further embodiment, a concertina fold (not shown) can be formed in sheet 820A by making a plurality of folds in sheet 820A, such that each fold opens in the opposite direction to its neighbor, giving a pleated effect.

It is to be understood that the present invention is not limited to the embodiments described above, but encompasses any and all embodiments within the scope of the following claims.

What is claimed is:

1. A waterproof book comprising:
a plurality of synthetic paper pages being substantially waterproof and tear-resistant; and
a pressure binding configured to bind the plurality of pages into book form while preserving structural integrity of the synthetic paper pages, and without piercing said pages.

2. The book of claim 1 wherein the pressure binding comprises:
an outer binding,
an inner binding, and
one or more fasteners for securing the outer binding to the inner binding, such the synthetic paper pages are held by pressure between the outer binding and the inner binding.

3. The book of claim 1 further comprising:
a cover formed from waterproof, nontearable materials and attached to the pressure binding.

4. The book of claim 3 wherein the cover comprises an audiovisual event generator.

5. The book of claim 3 wherein at least a portion of the cover is coated with a heat sensitive ink.

6. The book of claim 3 wherein at least a portion of the cover is hollow, the hollow portion forming a container.

7. The book of claim 6 wherein the hollow portion contains a liquid.

8. The book of claim 6 wherein the hollow portion contains a plurality of ornamental items.

9. The book of claim 6 wherein the cover comprises molded ABS plastic.

10. The book of claim 3 wherein the cover further comprises a handle.

11. The book of claim 1 wherein the pressure binding further comprises a handle.

12. The book of claim 1 wherein the synthetic paper pages resist tearing by a three-year-old child.

13. The book of claim 1 wherein the pressure binding comprises molded ABS plastic.

14. The book of claim 1 wherein the pages comprise high density nondirectional fibers.

15. The book of claim 1 wherein the pages are formed from spunbonded olefin.

16. The book of claim 1 wherein the pages are treated with a flame retardant.

17. The book of claim 1 wherein one or more of the pages has a flap formed therein.

18. The book of claim 1 wherein one or more of the pages has a concertina fold.

19. The book of claim 1 wherein one or more of the pages is embossed.

20. The book of claim 1 wherein the pages are printed by any one of offset printing, silkscreen printing, direct printing, sublimation printing, digital printing, laser printing, and ink jet printing.

21. The book of claim 1 wherein the edges of the pages are hemmed.

22. The book of claim 1 wherein the pages are formed from at least two layers of synthetic paper.

23. A pressure binding for a book, comprising:
a first portion,
a second portion,
the first and second portions having mutually interengaging faces for securing a plurality of pages therebetween, and
at least one fastener for joining the first and second portions together in interengaging relationship.

24. The pressure binding of claim 23, wherein the first portion is pivotably joined to the second portion.

25. The pressure binding of claim 23, wherein the first portion is pivotably joined to the second portion by a hinge.

26. The pressure binding of claim 25, wherein the hinge is integral to at least one of the first and second portions.

27. The pressure binding of claim 25, wherein the hinge is a living hinge integral with both the first portion and the second portion.

28. The pressure binding of claim 23, wherein each mutually interengaging face includes raised portions thereon for cooperating with the other interengaging face.

29. The pressure binding of claim 28, wherein the raised portions are formed integrally with their respective face.

30. The pressure binding of claim 28, wherein the raised portions of one face are complementary to the raised portions of the other face to enable said faces to be joined in complementary interengaging relationship.

31. A method for binding a book, comprising:
providing a plurality of substantially waterproof and tear-resistant sheets;
applying pressure to grip the sheets between an inner binding and an outer binding; and
fastening the inner binding to the outer binding to secure the sheets by pressure and without piercing the sheets.

32. A book comprising:
a plurality of substantially waterproof and tear-resistant pages;
means for pressure binding, comprising a first gripping means and a second gripping means for trapping the pages therebetween; and
means for fastening the first gripping means to the second gripping means, configured to secure the pages without piercing the pages.
